(19) United States
(12) Patent Application Publication
(10) Pub. No.: US 2014/0048169 A1
(43) Pub. Date: Feb. 20, 2014

(54) VALVE FOR PRESSURIZED FLUID, AND CORRESPONDING TANK AND FILLING METHOD

(71) Applicants: Philippe Pisot, Apprieu (FR); Denis Muller, Rueil Malmaison (FR); Jean-Paul Schaaff, Ezanville (FR)

(72) Inventors: Philippe Pisot, Apprieu (FR); Denis Muller, Rueil Malmaison (FR); Jean-Paul Schaaff, Ezanville (FR)

(73) Assignee: L'AIR LIQUIDE, SOCIETE ANONYME POUR I'ETUDE ET IEXPLOITATION DES PROCEDES GEORGE CLAUDE, Paris (FR)

(21) Appl. No.: 14/113,101

(22) PCT Filed: Mar. 28, 2012
(86) PCT No.: PCT/FR12/50643

§ 371 Date: Oct. 21, 2013

(30) Foreign Application Priority Data
Apr. 22, 2011 (FR) 1153495

(51) Int. Cl. F16K 1/30; F17C 5/06; F17C 13/04

(52) U.S. Cl. CPC F16K 1/307; F17C 13/04; F17C 5/06
USPC 141/4; 137/614.2; 137/523

(57) ABSTRACT

Pressurised-fluid tap for multiple fillings, in particular for a pressurised-gas reservoir, comprising a body (1) having a base (4) intended to be fixed at an orifice of a pressurised reservoir, the body (1) defining an internal circuit (5) for drawing-off/filling fluid extending between an upstream end (2) intended to be connected with the storage space of a reservoir and a downstream end (3) intended to be connected with a user member receiving or dispensing gas, the tap comprising, disposed in series in the circuit (5), a residual-pressure valve (6) and an isolation valve (7) distinct from the residual-pressure valve (6), the tap comprising a member (8) actuating the isolation valve (7) in order to selectively control the obstruction or not of the circuit (5), the actuation member (8) being able to move between a first so-called “closure” position in which the isolation valve (7) obstructs the circuit (5) and a second so-called “drawing-off” position in which the isolation valve (7) does not obstruct the circuit (5), characterised in that the residual-pressure valve (6) is situated upstream of the isolation valve (7) and in that the actuation member (8) can be moved into a third so-called “filling” position in which the actuation member forces the isolation valve (7) not to obstruct the circuit (5) and in which the residual-pressure valve (6) is moved into an opening position not obstructing the circuit (5), whatever the pressure differential on either side of the residual-pressure valve (6).

### CROSS REFERENCE TO RELATED APPLICATIONS

This application is a 371 of International PCT Application PCT/FR2012/050643 filed Mar. 28, 2012, the entire contents of which are incorporated herein by reference.

### BACKGROUND

The present invention concerns a pressurised-fluid tap, and a corresponding reservoir and filling method.

### SUMMARY

The invention concerns more particularly a pressurised-fluid tap for multiple fillings, in particular for a pressurised-gas reservoir, comprising a body having a base intended to be fixed at an orifice of a pressurised reservoir, the body defining an internal circuit for drawing-off/filling fluid extending between an upstream end intended to be connected with the storage space of a reservoir and a downstream end intended to be connected with a user member receiving or dispensing gas, the tap comprising, disposed in series in the circuit, a residual-pressure valve and an isolation valve, the tap comprising a member actuating the isolation valve, the actuation member being able to move between a first so-called “closure” position in which the isolation valve obstructs the circuit and a second so-called “drawing-off” position in which the isolation valve does not obstruct the circuit.

The majority of taps on gas bottles (with opening/closure by wheel or lever) having a non-return function (non-return valve=“NRV”) optionally associated with a function of maintaining a residual pressure (“RPV”=Residual Pressure Valve). These systems have made it possible to solve the problem of rupture of bottles related to the accidental introduction into the bottles of foreign media (liquids, gases) liable to react with the content and/or the container.

When the drawing-off port also serves as the filling port, it is necessary to use a special tool (such as a drift) to force the opening of the non-return/residual-pressure valve. This is because, failing this, the pressure of the filling gas tends to close these valves.

Accident studies, in particular in the case of reservoirs used for oxygen, show very great sensitivity of this coupling of the non-return/residual pressure valve and the drift member integrated in the filling coupling. This leads to incidents of high frequency: extrusions of gasket, ignition of gaskets and/or metals, etc.

One known solution consists of adding a piston of suitable design that is situated in the filling/drawing-off orifice of the tap. This piston, generally referred to as an “RPV/NRV valve” is routinely neutralisable mechanically by means of a drift integrated in the filling tool during operations of filling the reservoir. The various related dimensions are only rarely standardised. This causes dispersions in tolerance (depth of valve, valve travel) which may give rise to a geometric incompatibility between the RPV/NRV valve and the filling tool equipped with its drift. This may lead to damage to parts and/or uncontrolled gas flow-rate conditions.

The document EP 220193 describes a filling device intended to be connected to the inlet of a reservoir to be filled. This device comprises a gas entry connected to a pressurised-gas source and two exit orifices connected in parallel to the entry via respective valves. A first exit orifice is provided for being connected to the reservoir to be filled and the second orifice is provided for venting to atmosphere. The two valves are controlled by the respective positions of a pivoting lever for selectively either closing the two valves or opening only the outlet valve (to fill a reservoir) or to open only the vent valve (to vent the internal circuit of the device). This device is unsuited for use as a reservoir tap.

The document U.S. Pat. No. 5,018,552 describes a tap but for single use (without possible refilling). This tap comprises an upstream residual-pressure valve and a downstream isolation valve. A pusher makes it possible to selectively open the downstream isolation valve (on the outlet coupling side). The residual pressure valve is designed to prevent refilling of the reservoir.

The document U.S. Pat. No. 3,981,328 describes a pressurised-gas tap for multiple fillings, comprising an isolation valve and a residual-pressure valve disposed in series. The isolation valve is disposed upstream (on the reservoir side) and the residual-pressure valve is disposed downstream (on the filling/drawing-off port side). A rotary wheel controls the opening/closure of the isolation valve. To enable filling, a special tool is necessary to actuate a part concentric with the axis of the rotary wheel. This concentric part controls the opening of the downstream residual-pressure valve. This arrangement does however pose problems. This is because this architecture does not enable the user to know whether the residual pressure valve is open or whether it is functioning normally. Moreover, the downstream residual-pressure valve suffers a violent pressure shock at each opening of the main isolation valve by the user, which firstly causes significant mechanical fatigue and secondly may prove to be a factor propitious to ignitions due to the phenomenon of adiabatic compression under oxygen.

One aim of the present invention is to overcome all or some of the drawbacks of the prior art disclosed above.

To this end, the tap according to the invention, moreover in accordance with the generic definition given to it by the above preamble, is essentially characterised in that the residual-pressure valve is situated upstream of the isolation valve and in that the actuation member can be moved into a third so-called “filling” position in which the isolation valve does not obstruct the circuit and in which the residual-pressure valve is moved into an open position not obstructing the circuit, whatever the pressure differential on either side of the residual-pressure valve.

Moreover, embodiments of the invention may comprise one or more of the following features:

the downstream end of the circuit emerges at a filling/drawing-off port intended both for filling and drawing-off, that is to say the gas drawn off by the tap circulates from upstream to downstream in the circuit via the residual-pressure valve and the isolation valve while the filling gas circulates in the circuit from downstream to upstream also via the isolation valve and the residual-pressure valve,

the member actuating the isolation valve comprises a contact portion and, depending on the position of the actuation member relative to the body, the contact portion directly or indirectly actuates one end of the isolation valve,

in the first and second positions of the actuation member, the functioning of the residual-pressure valve is not altered, that is to say the residual-pressure valve closes off the circuit when the pressure differential between its upstream and downstream ends is below a given threshold and does not close off the circuit when the pressure differential between its upstream and downstream ends is above a given threshold,

in its third position, the actuation member moves the residual pressure valve into an open position not obstructing the circuit by means of the isolation valve,

the second drawing-off position of the actuation member is situated between the first closure position and the third filling position,

the first closure position of the actuation member is situated between the second drawing-off position and the third filling position,

the passage of the actuation member into the third filling position is possible only after the release of a bolt preventing access to the third position, the bolt (10) comprising at least one from: a mechanical bolt, a magnetic bolt,

the residual-pressure valve comprises a non-return mechanism (“NRV”) generating a force on the valve urging it towards its position obstructing the circuit when the valve is subjected to a pressure differential between the upstream and downstream sides above a given threshold,

the actuation member comprises a threaded spindle cooperating with a tapping in the body of the tap, the spindle being secured to a manually actuatable wheel or handle,

the actuation member comprises a lever articulated relative to the body, the lever comprising a cam profile cooperating with a spindle able to move in translation in the body of the tap,

the isolation valve comprises an obturator able to move relative to a seat and urged by a return member towards the seat in order to obstruct the circuit,

the residual pressure valve comprises an obturator able to move relative to a seat and urged towards the seat by a return member in order to obstruct the circuit,

the obturator of the residual-pressure valve is urged towards its seat by the return member from upstream to downstream,

the obturator of the isolation valve is urged towards its seat by the return member from upstream to downstream,

the return member or members comprise one or more springs, in particular compression springs,

the actuation member selectively actuates the isolation valve by pushing towards its position not obstructing the circuit,

when the isolation valve is in an extreme position not obstructing the circuit, the isolation valve actuates the residual-pressure valve by pushing into a position not obstructing the circuit,

the downstream end of the circuit forms a single orifice for filling and drawing-off fluid.

The invention also concerns a pressurised-gas reservoir comprising a tap according to any one of the above or following features.

The invention also concerns a method for filling a pressurised-gas reservoir comprising a tap with any one of the above or following features, the method comprising a step of moving the actuation member into its third filling position in order to open the residual-pressure valve and the isolation valve, and then a step of delivering a flow of fluid in the reservoir via the circuit, from downstream to upstream.

According to other particularities the tap comprises a disengagable bolt preventing by default access to the third position of the actuation member, the method comprising, prior to the step of moving the actuation member into its third filling position, a step of disengaging the bolt.

The invention may also concern any alternative device or method comprising any combination of the above or following features.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers. Other particularities and advantages will emerge from a reading of the following description given with reference to the accompanying figures, in which:

FIG. 1 shows a view in section, schematic and partial, illustrating a tap according to a first example embodiment of the invention, the two isolation and residual-pressure valves of which are closed,

FIG. 2 shows a view similar to the one in FIG. 1 in which the isolation valve is open and the residual-pressure valve is closed,

FIG. 3 shows a view similar to the one in FIG. 1 in which the isolation valve is open and the residual-pressure valve is open by pressure differential,

FIG. 4 shows a view similar to the one in FIG. 1 in which the isolation valve is open and the residual-pressure valve is open by forced mechanical action,

FIG. 5 shows a view in section, schematic and partial, illustrating a tap according to a second example embodiment of the invention, wherein the two isolation and residual-pressure valves are closed,

FIG. 6 shows a view similar to the one in FIG. 5 in which the isolation valve is open and the residual-pressure valve is closed,

FIG. 7 shows a view similar to the one in FIG. 1 in which the isolation valve is open and the residual-pressure valve is open by pressure differential,

FIG. 8 shows a view similar to the one in FIG. 1 in which the tap is mounted on a pressurised-fluid bottle, the isolation valve is open and the residual-pressure valve is open by forced mechanical action.

### DESCRIPTION OF PREFERRED EMBODIMENTS

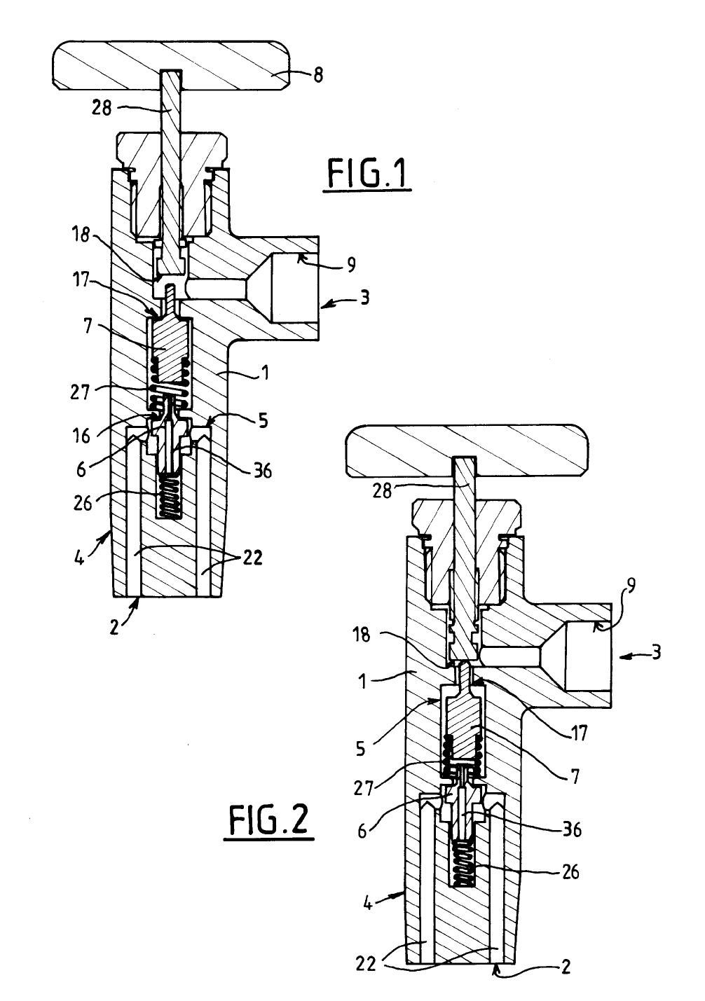

The tap illustrated in FIG. 1 comprises a body 1 provided with a base 4 intended to be fixed at an orifice of a pressurised reservoir. For example the base 4 is threaded.

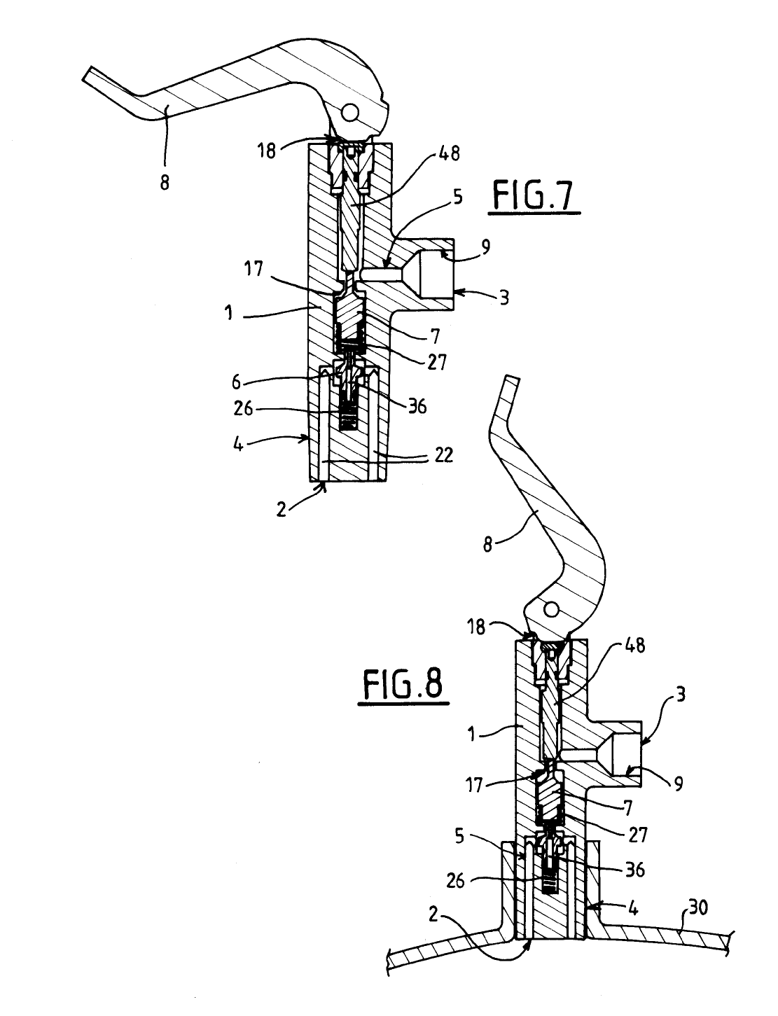

The body 1 defines an internal drawing-off/filling circuit 5 for the fluid. This circuit 5 extends between an upstream end 2 and a downstream end 3. The upstream end 2 emerges at the base 4 and is intended to be connected with the storage space of a reservoir (cf. reference 30, FIG. 8).

The downstream end 3 of the circuit 5 emerges at an orifice in the body 1, and preferably in a filling/drawing-off port 9 intended to be connected to a filling tool (flow of fluid from downstream 3 to upstream 2) or drawing-off tool (flow from upstream 2 to downstream 3).

The tap comprises, disposed in series in the circuit 5, a residual-pressure valve 6 and an isolation valve 7.

The residual-pressure valve 6 is situated upstream of the isolation valve 7.

The residual-pressure valve 6 comprises for example an obturator able to move relative to a seat 16 formed in the body 1. The movable obturator forming the valve 6 is urged towards the seat 16 by a return member 26 for obstructing the circuit 5. That is to say the residual-pressure valve 6 tends by default to obstruct (that is to say to close) the passage of fluid in the circuit 5. This residual-pressure valve 6 on the other hand opens if the pressure differential between its upstream and downstream ends is sufficient. In the example embodiment shown (in no way limitative), the obturator of the residual-pressure valve 6 is pushed towards the seat 16 from upstream to downstream. For example, one or two internal channels 22 connect the upstream end 2 of the circuit 5 to a downstream surface of the valve 6 so that, when the upstream pressure exceeds the force of the spring 26, the valve 6 is pushed upstream and moves away from its seat in order to open the circuit 5.

As shown, the residual-pressure valve 6 may comprise a non-return mechanism 36 (“NRV”) generating a force on the valve 6 urging it towards its position obstructing the circuit 5 when the valve 6 is subjected to a pressure differential between upstream and downstream above a given threshold.

The non-return mechanism 36 comprises, for example, an internal channel communicating respectively with the upstream and downstream parts of the circuit 5. In this way, when the fluid pressure is relatively great downstream (in the case of filling by the downstream end 3), pressurised fluid passes through the body of the valve 6 via the channel 36. The differential in downstream and upstream cross sections of the valve 6 is designed to cause in reaction a force that tends to close the valve 6 on its seat 16. This prevents “wild” fillings using the pressure of the fluid.

The isolation valve 7 may also comprise an obturator able to move relative to a seat 17. The obturator is urged towards the seat 17 by a return member 27 such as a spring 27 in order to obstruct the circuit 5 by default.

In the example embodiment shown (in no way limitative), the obturator of the residual-pressure valve 7 is pushed towards the seat 17 from upstream to downstream by a spring, for example a compression spring.

The tap comprises conventionally a member 8 for actuating the isolation valve 7 in order to selectively open the latter. The actuation member 8 comprises for example a top end forming a handle secured to a spindle 28 mounted so as to rotate in the body 1 of the tap. The spindle 28 is for example threaded and cooperates with a tapping in the body 1 of the tap. In a first closure position of the actuation member 8, the isolation valve 7 is closed.

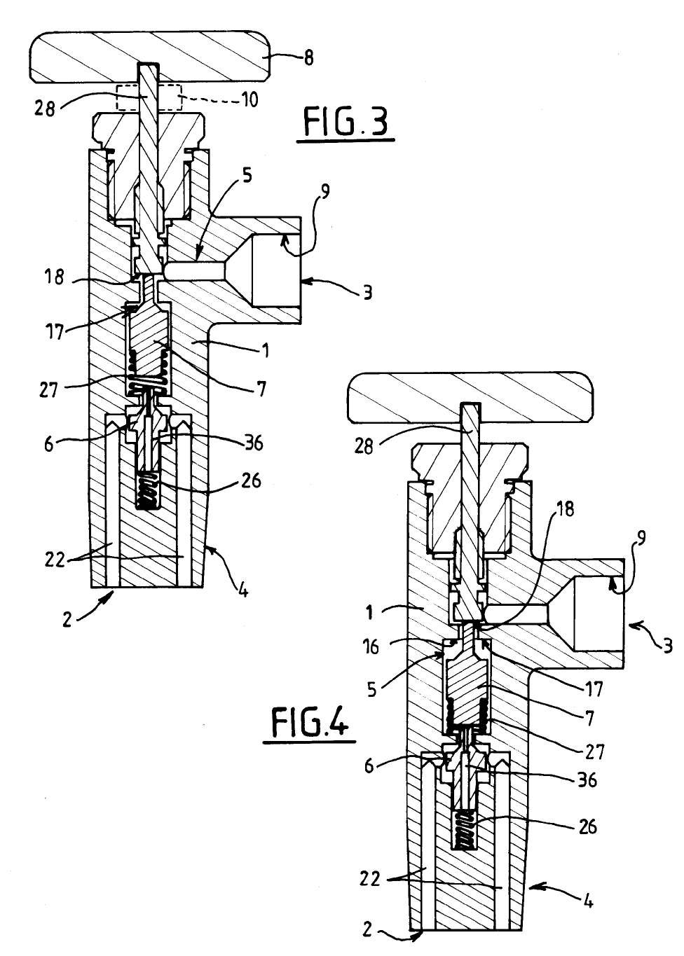

Depending on the rotation of the handle, in a second drawing-off position of the actuation member 8, the end 18 of the spindle 28 pushes the downstream side of the isolation valve 7 in order to separate it from its seat 17 and thus to open the passage of the circuit 5 (cf. FIGS. 1 and 2). In this position of opening the isolation valve 7, the residual-pressure and non-return valve 6 functions normally and is therefore closed (cf. FIG. 2) or open (cf. FIG. 3) according to the pressure differential between the upstream and downstream ends. This allows drawing-off from upstream 2 towards the downstream outlet 3.

For example, the isolation valve 7 is moved by a few millimetres (for example two to four millimetres) in order to provide a drawing-off flow from upstream to downstream without disturbing the functioning of the residual-pressure/non-return valve 6.

When the actuation member 8 is disposed in a third filling position (cf. FIG. 4), the end 18 of the spindle 28 pushes the isolation valve 7 into an extreme upstream position in which the isolation valve 7 pushes the residual-pressure and non-return valve 6 upstream. The residual-pressure and non-return valve 6 is thus opened mechanically, whatever the upstream-downstream pressure differential on either side of said valve 6. This makes it possible to fill a reservoir (circulation of fluid from downstream 3 to upstream 2).

In this position, the two valves 6, 7 provide sufficient passages for high filling rates (flow-rate coefficient Cv of around 0.4 for example), in order to limit the filling time without giving rise to any safety risk such as excessive heating.

The residual-pressure/non-return valve 6 is preferably placed in the same conduit of the circuit 5 and preferably on the same axis as the isolation valve 7. Other orientations may however be envisaged enabling the valve 6 to be actuated by the isolation valve 7.

This architecture makes it possible to dispose the residual-pressure/non-return valve 6 upstream of the isolation valve while simplifying the connection kinematics during filling operations.

This is because this architecture makes it possible to dispense with a drift in the filling tool. A single actuation member 8 makes it possible to manage all the configurations (closure/drawing-off/filling).

The filling operations (connection of a filling tool on the port 9 of the tap, filling proper, disconnection of the tool) as well as the maintenance operations are therefore greatly simplified and become more reliable.

The first position (cf. FIG. 1) of the actuation member 8 makes it possible to secure the closure, for example for a reservoir transport phase. The second position (cf. FIGS. 2 and 3) of the actuation member 8 allows drawing off. The third position (cf. FIG. 4) of the actuation member 8 allows filling. An intermediate position can be envisaged between the first and second positions in which the isolation valve is closed but the end of the spindle fits flush with the isolation valve 7 in order to be ready for rapid opening.

Preferably, the third position of the actuation member 8 is not easily accessible or accessible only via a particular kinematics or accessible only after a greater force or a release of a bolt 10 (cf. FIG. 3) preventing access to the third position. The bolt 10 comprises for example at least one from: a mechanical bolt, a magnetic bolt.

Preferably, the return to a position other than the third position automatically re-triggers locking, for example elastically.

At least one of the above positions may where applicable be stable and marked in the movement of the actuation member 8.

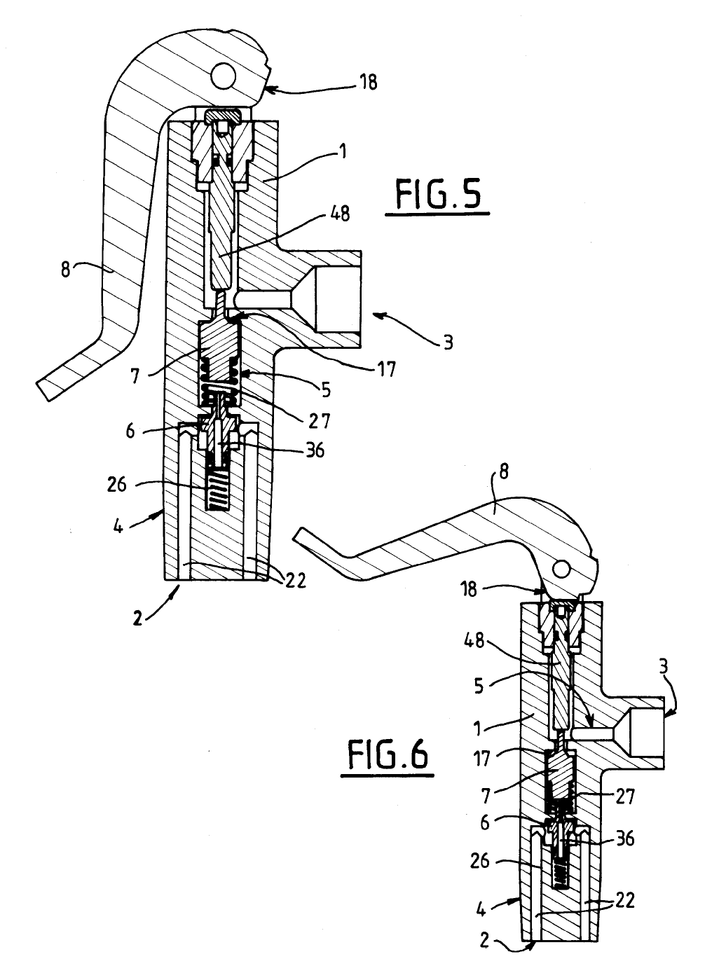

FIGS. 5 to 8 illustrate another variant embodiment of the tap. The elements identical to those described above are designated by the same numerical references and are not described a second time. The embodiment in FIGS. 5 to 8 is distinguished from that in FIGS. 1 to 4 only in that the actuation member 8 comprises a lever articulated on the body and in that, in FIG. 8, the tap is mounted in the orifice of a reservoir 30. The open/closed states of the two valves 6, 7 in FIGS. 5 to 8 correspond respectively to the states in FIGS. 1 to 4.

The actuation member 8 comprises a lever articulated relative to the body 1. The lever comprises for example a cam profile 18 cooperating with a first end of a spindle 48 able to move in translation in the body 1 of the tap (in a fluidtight manner). The second end of the movable spindle 48 comes into contact with the downstream end of the isolation valve 7.

In the first position (cf. FIG. 5, the two valves 6, 7 being closed) the lever of the actuation member 8 is for example disposed along the body (but not necessarily, another angular position of the lever could correspond to this closure state).

In the second drawing-off position (cf. FIGS. 6 and 7, the isolation valve 7 being open) the lever of the actuation member 8 is for example pivoted by an angle of 20° to 120° with respect to the first position.

In the third filling position (cf. FIG. 8, the valves 7 being opened mechanically) the lever of the actuation member 8 is for example pivoted by an angle of 120° to 320° with respect to the first position.

As before, the positions may where applicable be stable and marked in the movement of the actuation member 8, for example via a suitable cam profile 1.

Likewise, the third position of the actuation member 8 is not easily accessible or accessible only via particular kinematics or accessible only after a force or a release of a bolt preventing by default access to the third position.

In all cases, the second drawing-off position of the actuation member 8 may be situated for example either between the first closure position and the third filling position, or between the second drawing-off position and the third filling position.

1. Pressurised-fluid tap for multiple fillings, in particular for a pressurised-gas reservoir, comprising a body (1) having a base (4) intended to be fixed at an orifice of a pressurised reservoir, the body (1) defining an internal circuit (5) for drawing-off/filling fluid extending between an upstream end (2) intended to be connected with the storage space of a reservoir and a downstream end (3) intended to be connected with a user member receiving or dispensing gas, the tap comprising, disposed in series in the circuit (5), a residual-pressure valve (6) and an isolation valve (7) distinct from the residual-pressure valve, the tap comprising a member (8) actuating the isolation valve (7) in order to selectively control the obstruction or not of the circuit (5), the actuation member (8) being able to move between a first so-called “closure” position in which the isolation shutter (7) obstructs the circuit (5) and a second so-called “drawing-off” position in which the isolation valve (7) does not obstruct the circuit (5), characterised in that the residual-pressure valve (6) is situated upstream of the isolation valve (7) and in that the actuation member (8) can be moved into a third so-called “filling” position in which the actuation member (8) forces the isolation valve (7) not to obstruct the circuit (5) and in which the residual-pressure valve (6) is moved into an opening position not obstructing the circuit (5), whatever the pressure differential on either side of the residual-pressure valve (6).

2. Tap according to claim 1, characterised in that the downstream end (3) of the circuit emerges at a filling/drawing-off port (9) intended both for filling and drawing-off, that is to say the gas drawn off by the tap circulates from upstream (2) to downstream (3) in the circuit (5) via the residual-pressure valve (6) and the isolation valve (7) while the filling gas circulates in the circuit (5) from downstream (3) to upstream (2) also via the isolation valve (7) and the residual-pressure valve (6).

3. Tap according to claim 1 or 2, characterised in that the member (8) actuating the isolation valve (7) comprises a contact portion (18) and, depending on the position of the actuation member (8) relative to the body (1), the contact portion (18) directly or indirectly actuates one end of the isolation valve (7).

4. Tap according to any one of claims 1 to 3, characterised in that, in its first and second positions, the actuation member (8) does not force the functioning or the position of the residual-pressure valve (6), that is to say the residual-pressure valve (6) closes off the circuit (5) when the pressure differential between its upstream and downstream ends is below a given threshold and does not close off the circuit (5) when the pressure differential between its upstream and downstream ends is above a given threshold.

5. Tap according to any one of claims 1 to 4, characterised in that, in its third position, the actuation member (8) moves the residual-pressure valve (6) into an open position not obstructing the circuit (5) by means of the isolation valve (7).

6. Tap according to any one of claims 1 to 5, characterised in that the second drawing-off position of the actuation member (8) is situated between the first closure position and the third filling position.

7. Tap according to any one of claims 1 to 6, characterised in that the residual pressure valve (6) comprises an obturator able to move relative to a seat, the obturator being urged towards the seat via a return member, the isolation valve (7) comprising an obturator distinct from that of the residual-pressure valve (6), able to move relative to a seat distinct from that of the residual-pressure valve (6) and urged towards its seat via a return member distinct from that of the residual-pressure valve (6).

8. Tap according to any one of claims 1 to 7, characterised in that, in its third position, the actuation member (8) moves the isolation valve (7) into an extreme upstream position not obstructing the circuit (5) and in which the isolation valve (7) actuates by pushing the residual-pressure valve (6) into a position not obstructing the circuit.

9. Tap according to any one of claims 1 to 8, characterised in that it comprises a bolt (10) for limiting the movement of the actuation member (8) and in that the passage of the actuation member (8) into the third filling position is possible only after the release of the bolt (10) preventing access to the third position, the bolt (10) comprising at least one from: a mechanical bolt, a magnetic bolt.

10. Tap according to any one of claims 1 to 9, characterised in that the residual-pressure valve (6) comprises a non-return mechanism (“NRV”) generating a force on the valve (6) urging it towards its position obstructing the circuit when the valve (6) is subjected to a pressure differential between upstream and downstream above a given threshold.

11. Tap according to any one of claims 1 to 10, characterised in that the actuation member (8) comprises a threaded spindle (28) cooperating with a tapping in the body (1) of the tap, the spindle (28) being secured to a manually actuatable wheel or handle.

12. Tap according to any one of claims 1 to 10, characterised in that the actuation member (8) comprises a lever articulated relative to the body (1), the lever comprising a cam profile (18) cooperating with a spindle (48) able to move in translation in the body (1) of the tap.

13. Pressurised-gas reservoir comprising a tap according to any one of claims 1 to 12.

14. Method for filling a pressurised-gas reservoir comprising a tap according to any one of claims 1 to 13, characterised in that it comprises a step of moving the actuation member (8) into its third filling position in order to open the residual-pressure valve (6) and the isolation valve (7), and then a step of delivering a flow of fluid in the reservoir via the circuit (5), from downstream (3) to upstream (2).

15. Method according to claim 14, characterised in that the tap comprises a disengageable bolt preventing by default access to the third position of the actuation member (8) and in that the method comprises, prior to the step of moving the actuation member (8) into its third filling position, a step of disengaging the bolt.
